(19) United States
(12) Patent Application Publication
(10) Pub. No.: US 2008/0224003 A1
(43) Pub. Date: Sep. 18, 2008

(54) Adhesion Method and Adhesion Device for a Wall Hanger Plaster and a Base

(76) Inventor: Yung-Huei Lan, Taiwan (CN)

Correspondence Address: BACON & THOMAS, PLLC, 625 SLATERS LANE, FOURTH FLOOR, ALEXANDRIA, VA, 22314-1176, US

(21) Appl. No.: 10/589,502

(22) PCT Filed: Nov. 29, 2005
(86) PCT No.: PCT/CN05/02045

§ 371 Date: Aug. 15, 2006

(30) Foreign Application Priority Data
May 23, 2005 (CN) 200510034731.9

(51) Int. Cl. F16B 47/00; A47G 29/087

(52) U.S. Cl. 248/205.3

(57) ABSTRACT

An adhesion method for a wall hanger paster and a base comprises the steps: spreading liquid glue or dissolvent on the center of the bottom face of the base or melting the bottom face of the base with instant high heat; bending the paster to be an arc shape; and pressing the paster toward the bottom face of the base, the bulgiest point of the center of an arc face connecting to the base, and then gradually pressing the paster to make the paster and the base gradually stick together. An adhesion device for a wall hanger and a base comprises an upper mold and a lower mold. The upper mold has a paster clamping board having holes, a clamping trough, a base holding board having pillars, and the center place of the base holding board having a base installed groove corresponding to the fixing place of the paster.

### FIELD OF THE INVENTION

The present invention relates to a living accessory and particularly an adhesion method and an adhesion device for a wall hanger paster and a base.

### BACKGROUND OF THE INVENTION

Conventional living wall hangers such as hangers stick on the wall surface have small volume so that they are popular in public. Most of hangers stick on the wall or glass on the marker are fixed on the wall by the hanger base passing through fastenings such as screws or by pasting adhesive materials on the wall surface which is connected to the hanger base. However, those hangers have the following problems.

Although the hanger is secure because the hanger is fixed on the wall by the hanger base passing through fastenings such as screws, it requires to bore a hole to fasten the fastenings such as screws. That way would destroy the aesthetic of the whole wall. For an integrated tile wall, it is easy to break the whole tile wall by boring a hole and the hanger can only secure on one place. If people would like to change the hanger to other place, people have to bore another hole. Thus, there are many vestiges or useless holes on the wall. Although the hanger fixed on the wall by pasting adhesive materials on the wall surface which is connected to the hanger base can solve the problem of damaging wall appearance, the hanger still can be fixed on one place. The wall or other hang surface is easy getting dirty because the adhesive material would stain the wall by residual glue when moving the hanger. Moreover, when using for a longer time or cleaning the hanger fixed by pasting adhesive material with the detersive or water, the adhesive material is easy to lose efficacy and results in the hanger falling off.

Since those products have the above-mentioned disadvantages, the applicant applies for a wall hanger which has a paster to connect with the hanger base. By the paster having stronger adhesion, the hanger can be stuck on the wall or glass and is convenient to change, with no residual glue, completely waterproof, and can be washed with the detersive or water to satisfy people's requires. At present, the coupling way for this kind of hanger paster and base is generally to drop glue on the base or heat and melt the bottom face of the base and then stick a paster on it. Since after sticking the paster by the common way of dropping glue, the glue is hard to evenly spread and the enforce is uneven when sticking so that the connection part of the paster and the base is easy to generate bubbles and the coupling face would be not close. After using for a period, the paster would be easy to fall off and the lifespan of the paster is affected.

### SUMMARY OF THE INVENTION

The present invention aims to overcome the above disadvantages and provides an adhesion method for a wall hanger paster and a base. The air between the paster and the base can be eliminated when coupling and the goal of tightly coupling can be achieve because the bubbles are not easy to generate.

To achieve the above inventive purpose, the present invention provides:

An adhesion method for a wall hanger and a base comprising the following steps:

a. spreading liquid glue or dissolvent on the center of the bottom face of the base or melting the bottom face of the base with instant high heat;

b. bending the paster to be an arc shape;

c. pressing the paster toward the bottom face of the base, the bulgiest point of the center of an arc face connecting to the base, and then gradually pressing the paster to make the paster and the base stick together;

wherein the arc face of the paster when bending is the symmetrical arc face of the center line of the paster; and

before the present invention being stuck together, the adhesive position of the paster and the base is spread a layer of corresponding glue or dissolvent.

An adhesion device for a wall hanger and a base is characterized in that it comprises an upper mold and a lower mold, the upper mold having a paster clamping board, a clamping trough being able to clamp and fix the bent paster under the paster clamping board, and the paster clamping board having a plurality of holes; the lower mold having a base holding board, the base holding board having a plurality of pillars corresponding to the holes of the paster clamping board, and the center place of the base holding board having a base installed groove corresponding to the fixing place of the paster for receiving the base.

Two ends of the paster clamping board have two movable battens covering on the paster clamping board. By a batten pulling spring connecting, the paster pushing board is installed on the paster clamping board and wedged between two battens. A pushing point is installed in a corresponding aperture of the paster clamping board.

A bottom surface of the paster clamping board has a soft elastomer which can couple with the arc-shaped paster.

Connecting parts of the batten and the paster pushing board are slideable inclined planes corresponding to each other.

A stopping excess flow ring is installed on the peripheral of the base installed groove conducting with a total excess flow pipe by passing trough a ring groove or a discharge hole for solution of the base holding board.

The batten clasps an extended end of the paster clamping board slightly jutting out over an inner side of the clamping trough, and an outward side of the extended end is an inclined plane.

The center of the bottom of the paster pushing board has a spring trough for receiving a stress spring located between the paster pushing board and the paster clamping board.

The ring surface of the stopping excess flow ring is higher than the bottom face of the base put in the base installed groove.

The stopping excess flow ring is a soft material which can fit the shape of the paster surface being changed or curved and tightly stick on the paster.

Since the sticking action is reasonable according to the present invention, the paster can stick on the line of balance place of the center of the base and the air can be discharged between them so that it is hard to have bubbles and the connection of the paster and the base is very secure. The paster will not fall off easily and have strong pulling force. Besides, the paster will not be out of shape and can be entirely stuck on the wall. The even surface of the paster will make no residual air between the wall and the paster so that it can stick on the wall tightly and effectively prolong the lifespan of this kind of hanger.

The present invention has a simple configuration because the paster and the base can be coupled together not only by hand pressing but also by other device to achieve the mechanism pressing. It is convenient to use and has the advantage of positioning accuracy when manufacturing so that the paster and the base can couple together tightly and stick securely and the adhesive quality and quantity can be guaranteed. Furthermore, the stopping excess flow ring installed on the peripheral of the base installed groove can prevent glue or solution discharging and polluting the device.

### BRIEF DESCRIPTION OF THE DRAWINGS

FIG. 1 is a device assembly view of a first preferred embodiment of the present invention.

FIG. 2 is a main view of an upper mold of the first preferred embodiment of the present invention.

FIG. 3 is a top view of the upper mold of the first preferred embodiment of the present invention.

FIG. 4 is a left view of the upper mold of the first preferred embodiment of the present invention.

FIG. 5 is a top view of a lower mold of the first preferred embodiment of the present invention.

FIG. 6 is a main view of the lower mold of the first preferred embodiment of the present invention.

FIG. 7 is a top view of the lower mold of a second preferred embodiment of the present invention.

FIG. 8 is a main view of the lower mold of the second preferred embodiment of the present invention.

FIG. 9 is a schematic view of an adhesion method for a paster and a base of the present invention.

### DETAILED DESCRIPTION OF THE PREFERRED EMBODIMENTS

The present invention provides an adhesion method for a wall hanger and a base comprising the following steps:

a. spreading liquid glue or dissolvent on the center of the bottom face of a base or melting the bottom face of a base with instant high heat, which is the necessary step of the base and a paster sticking together;

b. bending the paster to be an arc shape;

c. pressing the paster toward the bottom face of the base, the bulgiest point of the center of an arc face connecting to the base, and then gradually pressing the paster to make the paster and the base stick together;

wherein the arc face of the paster when bending is the symmetrical arc face of the center line of the paster; and before coupling together, the adhesive position of the paster and the base is spread a layer of corresponding glue or dissolvent.

The common skill is both corresponding planes sticking together. However, the applicant found that there must be interspaces when sticking since both plans are not absolutely even. If glue or solution dose not spread completely, bubbles would be generated. Besides, when two planes are stuck together, a tiny eddy or air turbulence may be generated. If there is no effective way to discharge the air, it must have bubbles generated between solution and the planes so that the interspaces of two planes make the hanger not sticky enough. The present invention designs the paster being bent to be an arc shape, and the arc face is a symmetrical face according to the center line of the paster. Liquid glue or solution located in the center of the base will flow along the center line because of adhering to the highest line of the arc face and liquid glue or solution will form a long-strip shape glue (or solution) area. When the paster keeps on pressing toward the base, both sides of the long-strip shape glue area will broaden gradually, and glue or solution will move outward gradually. During the process of moving, the surface of the base is full of glue and stuck with the paster.

The following description is accompanied with the drawings for detail description of the present invention.

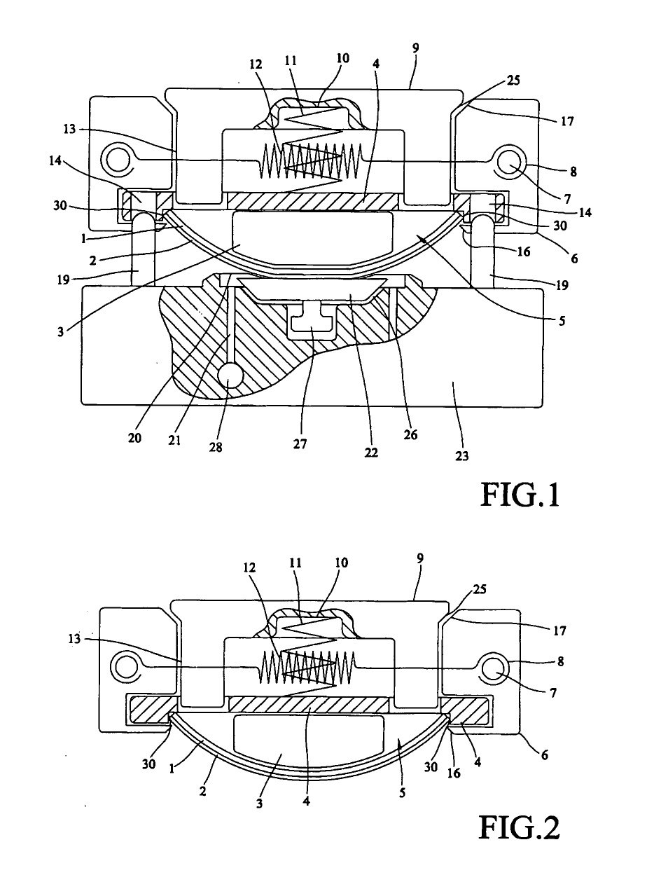

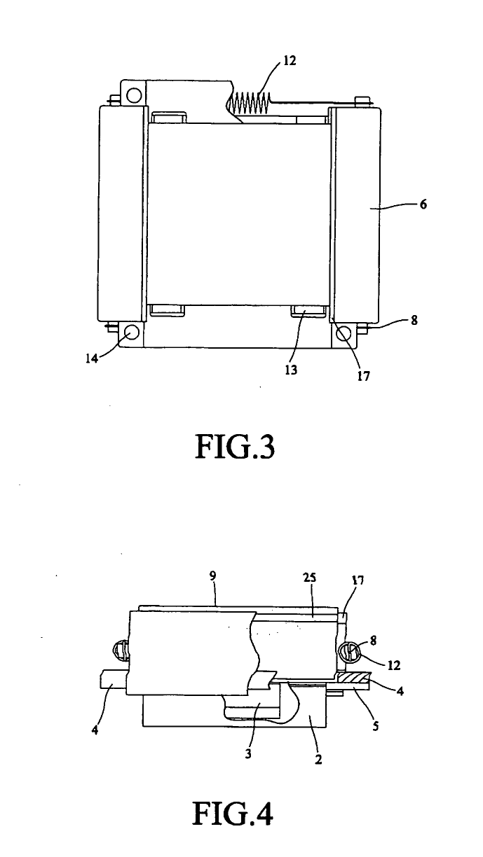

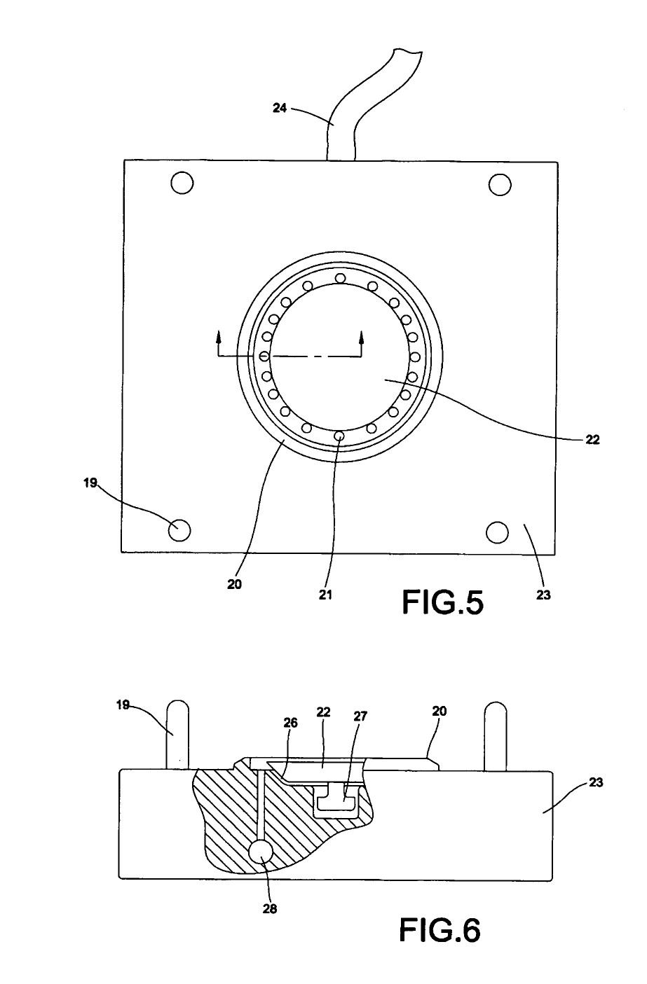

FIG. 1 to FIG. 6 show an adhesion device of a first preferred embodiment of the present invention.

FIG. 1 is a device assembly view of the first preferred embodiment of the present invention. The assembly configuration will be stated as following elements.

As shown in FIG. 1 to FIG. 4, the present invention comprises an upper mold and a lower mold. The upper mold includes a paster clamping board 4, a batten 6, and a paster pushing board 9. A clamping trough 5 able to clamp and fix a bent paster 2 is under the paster clamping board 4. Both ends of the clamping trough 5 have inner sides 30 to clamp the paster 2. To form a correct arc shape of bending a paster 2 clamped in the paster clamping board 4, and to give a suitable pressure for the paster 2 when sticking, a soft elastomer 3 is installed in the clamping trough 5 of the paster clamping board 4 to stick with the arc-shaped paster 2 and push the paster 2. Also, it can prevent the paster 2 being out of shape when the paster clamping board 4 is pressed downward. The paster clamping board 4 has a plurality of holes 14 (such as two sets, four holes). Two battens 6 are located on two ends of the paster clamping board 4. The batten 6 has an extended end which is located on the edge of the opening of the clamping trough 5, and is jutting out toward the clamping trough 5 and covers the inner side 30 of the clamping trough 5, and clamps two ends of the paster 2 to prevent the paster 2 falling off. A conductive inclined plane 16 is installed in the opposite direction of the outward side of the end toward the paster. When a firm paper 1 sticking on the back of the paster 2 and the paster 2 pass through the conductive inclined plane 16, it is convenient to be wedged into the clamping trough 5. To easily depart and take off the paster 2 stuck in the clamping trough 5 by battens 6, the battens are designed to be movable and connected with a batten pulling spring 12. Both ends of the batten pulling spring 12 have spring hooks 8 which hang on spring fixing bolts 7. The inner side of the batten 6 toward the clamping trough 5 has a groove. Both ends of the paster clamping board 4 can be put into the groove and coupled together, and can slide along the groove so that the paster will not be stuck when departing because the extended end jutting from the groove will hold back and not block the edge of the opining of the clamping trough 5. The paster pushing board 9 and the paster 2 are located different sides of the paster clamping board 4 respectively. Since it is not very secure when the paster 2 and a base 22 just stick together, for the paster 2 departing from the clamping trough 5 more successfully, a top end 13 for connecting the paster pushing board 9 will be push forward to the direction of the paster 2 departing from the clamping trough 5 so that both ends of the paster 2 will depart from the inner sides 30 of the clamping trough 5 and depart from the opining of the clamping trough 5. Thus, the paster clamping board 4 has an aperture for the top end 13 passing through and pushing the paster 2 located on another side of the paster clamping board 4. Before the top end 13 of the paster pushing board 9 pushing the paster forward, the pushing direction is vertical to the direction of the batten holding back, a released inclined plane 17 is installed on the batten 6 and a justling inclined plane 25 is correspondingly installed on the paster pushing board 9, and the released inclined plane 17 and the justling inclined plane 25 are inclined planes sliding according to each other, thus, the batten 6 and the paster pushing board 9 can move together in the vertical direction according to each other at the same time. In the beginning of the pushing process for the paster pushing board 9, as the top end 13 dose not touch the paster 2, the justling inclined plane 25 has connected to and pushed the released inclined plane 17, the batten 6 holds back and releases the paster 2 so that the top end 13 can push the paster 2 to depart from the clamping trough 5.

For returning the top end 13 to the original position after the pushing process, the center part of the top end 13 has a spring trough 10. A stress spring 11 of the top end 13 is located between the paster pushing board 9 and the paster clamping board 4. One end of the stress spring 11 is installed in the spring trough 10 and the other end is installed on the paster clamping board 4. For returning the top end 13 to the original position after holding back and releasing, a batten returning spring can be selectively installed.

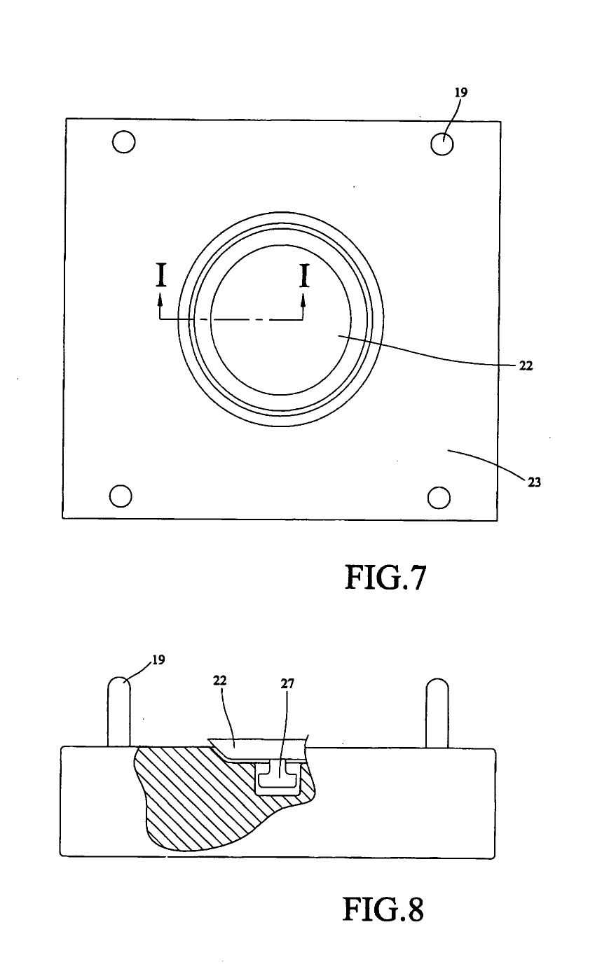

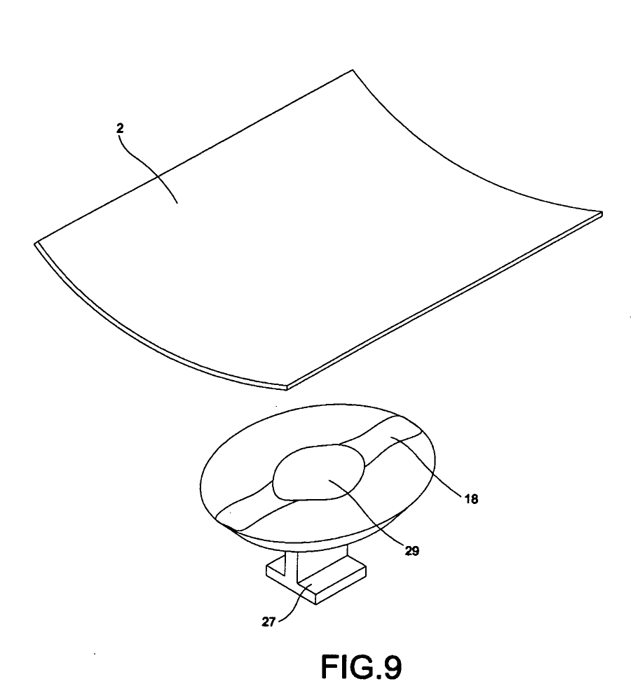

FIG. 5 and FIG. 6 show the configuration of a lower mold. The lower mold includes a base holding board 23. The base holding board 23 has pillars 19 respectively located on four corners of the base holding board 23 corresponding to the holes 14 of the upper mold. When the pillars 19 insert into the holes 14, the paster 2 of the upper mold and the base 22 of the lower mold can be accurately positioned. The base 22 is located under the accurate position of the paster 2. At the same time, the upper mold will move up and down along the pillar 19 to make the paster 2 and the base 22 gradually couple together. The base holding board 23 has a base installed groove 26. The base 22 can be wedged in the base installed groove 26. The bottom of the base has a J-shaped supporting element 27 to hold all kinds of products which hook up with the supporting element 27. A stopping excess flow ring 20 is installed on the peripheral of the base installed groove 26. The stopping excess flow ring 20 is soft and can fit the shape of the surface of the paster 2 being changed or curved and tightly stick on the paster 2. The ring surface of the stopping excess flow ring 20 is higher than the bottom face of the base 22 put in the base installed groove 26. The surface of the paster 2 will be changed and curved by pressing so that the paster 2 will connect to the stopping excess flow ring 20 before touching the base during the adhesion process. Since the stopping excess flow ring 20 is very soft, when the paster 2 connects to the stopping excess flow ring 20, the stopping excess flow ring 20 will change the shape according to the surface of the paster 2. Then, the paster 2 can keep on pressing toward the base 22. Thus, the stopping excess flow ring 20 can always effectively block glue or solution flowing from the paster 2 to the peripheral of the paster 2 on the peripheral of the base 22 connecting to the paster 2. The base installed groove 26 can further have a ring groove or 10 to 20 discharge holes 21 for glue or solution to conduct with the ring groove or a water pipe 28 of the discharge hole 21 and a total excess flow pipe 24 for solution or glue. To ensure that the adhesive face is full of glue or solution, more glue or solution is required. When the paster 2 is pressed toward the base 22, glue of solution between the paster 2 and the base 22 is squeezed out. The squeezed glue or solution will flow to the place where dose not need glue or solution along the paster 2 to the peripheral of the paster 2, and will be blocked by the stopping excess flow ring 20 and flow downward into the discharge hole 21. Redundant glue or solution 29 (as shown in FIG. 9) will be discharged from the device by passing through the water pipe 28 and the total excess flow pipe 24.

FIG. 7 and FIG. 8 show the view of the lower mold of a second preferred embodiment of the present invention. In the preferred embodiment, the bottom face of the base 22 is melt by instant high heat and sticks with the paster 2. Since liquid glue or solution is not needed, the stopping excess flow ring 20, the discharge hole 21, the water pipe 28, and the total excess flow pipe 24 are not required. The configuration and operation are the same as the first preferred embodiment and will not describe the detail.

The operating relationship is as follow: bending the paster 2 sticking with the firm paper 1 and passing the paster 2 through the conductive inclined plane 16 of the batten 6 and then being wedged into the clamping trough 5 of the paster clamping board 4. When the paster 2 is pressed toward the bottom face of the base 22, the jutting highest line of the arc face will connect to the base 22 firstly, at this time, the glue or solution 29 on the center of the base 22 will adhere to the highest line of the arc face and flow along the line to form a long-strip shape glue (solution) area 18. When the paster 2 keeps on pressing toward the base 22, both sides of the long-strip shape glue area 18 will broaden gradually. When the center of the paster 2 is pressed to be even and adhered to the base 22, the surface of the base 22 has been full of the glue or solution 29 and sticks with the paster 2. Since this adhering action is gradually extending from the center line to two sides in sequence, the air can be discharged and bubbles can not be easily included. This could fasten the adhesion of the base 22 and the paster 2. The redundant glue or solution 29 will be blocked by the stopping excess flow ring 20 and flow downward into the discharge hole 21 and be discharged from the device by passing through the total excess flow pipe 24. When the paster 2 and the base 22 completely stick with each other, two ends of the paster 2 are connected to the inner sides 30 of the clamping trough 5 and clamped into the clamping trough 5 which means that the stuck wall hanger is still clamped in the clamping trough 5 and locked with the extended end of the batten 6. If pulling it by force, the stuck edge could be stripped because of the stuck wall hanger is just finished and not firm enough. At this time, moving the paster pushing board downward, the justling inclined plane 25 will connect to and push the released inclined plane 17, and the batten 6 will hold back and release the paster 2. The pushing process will keep going. The top end 13 is moved downward a certain distance and then connects to and pushes the paster such that the paster 2 can be pushed to depart from the clamping trough 5. Then, removing the force, the stress spring 11 starts to work and make the paster pushing board 9 upward and return to the original position. The batten 6 will return to the original position toward the center under the force of the batten pulling spring 12 and wait for the next operation beginning.

1. An adhesion method for a wall hanger and a base comprises the following steps:
a. spreading liquid glue or dissolvent on the center of the bottom face of the base or melting the bottom face of the base with instant high heat;
b. bending the paster to be an arc shape; and
c. pressing the paster toward the bottom face of the base, the bulgiest point of the center of an arc face connecting to the base, and then gradually pressing the paster to make the paster and the base gradually stick together;

2. The adhesion method of claim 1, wherein the characteristic is that the arc face of the paster when bending is the symmetrical arc face of the center line of the paster.

3. The adhesion method of claim 1, wherein the characteristic is that before sticking together, the adhesive position of the paster and the base is spread a layer of corresponding glue or dissolvent.

4. An adhesion device for a wall hanger and a base, characterized in that it comprises an upper mold and a lower mold, the upper mold having a paster clamping board, a clamping trough being able to clamp and fix the bent paster under the paster clamping board, and the paster clamping board having a plurality of holes; the lower mold having a base holding board, the base holding board having a plurality of pillars corresponding to the holes of the paster clamping board, and the center place of the base holding board having a base installed groove corresponding to the fixing place of the paster for receiving the base.

5. An adhesion device of claim 4, wherein the characteristic is that two ends of the paster clamping board have two movable battens covering on the paster clamping board, by a batten pulling spring connecting, the paster pushing board is installed on the paster clamping board and wedged between two battens, and a pushing point is installed in a corresponding aperture of the paster clamping board.

6. The adhesion device of claim 4, wherein the characteristic is that a bottom surface of the paster clamping board has a soft elastomer which can stick with the arc-shaped paster.

7. The adhesion device of claim 4, wherein the characteristic is that a stopping excess flow ring is installed on the peripheral of the base installed groove conducting with a total excess flow pipe by passing trough a ring groove or a discharge hole for solution of the base holding board.

8. The adhesion device of claim 5, wherein the characteristic is that connecting parts of the batten and the paster pushing board are slideable inclined planes corresponding to each other.

9. The adhesion device of claim 5, wherein the characteristic is that the batten clasps an extended end of the paster clamping board slightly jutting out over an inner side of the clamping trough, and an outward side of the extended end is an inclined plane.

10. The adhesion device of claim 5, wherein the characteristic is that the center of the bottom of the paster pushing board has a spring trough for receiving a stress spring located between the paster pushing board and the paster clamping board.

11. The adhesion device of claim 7, wherein the characteristic is that the ring surface of the stopping excess flow ring is higher than the bottom face of the base put in the base installed groove.

12. The adhesion device of claim 7, wherein the characteristic is that the stopping excess flow ring is a soft material which can fit the shape of the paster surface being changed or curved and tightly stick on the paster.

13. The adhesion device of claim 5, wherein the characteristic is that a bottom surface of the paster clamping board has a soft elastomer which can stick with the arc-shaped paster.

14. The adhesion device of claim 5, wherein the characteristic is that a stopping excess flow ring is installed on the peripheral of the base installed groove conducting with a total excess flow pipe by passing trough a ring groove or a discharge hole for solution of the base holding board.

15. The adhesion device of claim 14, wherein the characteristic is that the ring surface of the stopping excess flow ring is higher than the bottom face of the base put in the base installed groove.

16. The adhesion device of claim 14, wherein the characteristic is that the stopping excess flow ring is a soft material which can fit the shape of the paster surface being changed or curved and tightly stick on the paster.

17. The adhesion device of claim 11, wherein the characteristic is that the stopping excess flow ring is a soft material which can fit the shape of the paster surface being changed or curved and tightly stick on the paster.

18. The adhesion device of claim 15, wherein the characteristic is that the stopping excess flow ring is a soft material which can fit the shape of the paster surface being changed or curved and tightly stick on the paster.
